(19) United States
(12) Patent Application Publication
(10) Pub. No.: US 2008/0101202 A1
(43) Pub. Date: May 1, 2008

(54) Optical pickup

(76) Inventors: Masahiko Nishimoto, Osaka (JP); Masayuki Ono, Osaka (JP); Hiroaki Yamamoto, Hyogo (JP)

Correspondence Address: MCDERMOTT WILL & EMERY LLP, 600 13TH STREET, NW, WASHINGTON, DC, 20005-3096, US

(21) Appl. No.: 11/826,245

(22) Filed: Jul. 13, 2007

(30) Foreign Application Priority Data
Oct. 31, 2006 (JP) 2006-295258

(51) Int. Cl. G11B 7/09

(52) U.S. Cl. 369/112.07

(57) ABSTRACT

An optical pickup includes a hologram element divided into four regions in a direction parallel to a tracking direction of an optical information recording medium and a direction perpendicular thereto. The hologram element allows two pairs of diffracted lights from two paired regions adjacent in parallel with the tracking direction to be made incident into light receiving elements so as to align in the direction perpendicular to the tracking direction.

### CROSS-REFERENCE TO RELATED APPLICATIONS

This Non-provisional application claims priority under 35 U.S.C. §119(a) on Patent Application No. 2006-295258 filed in Japan on Oct. 31, 2006, the entire contents of which are hereby incorporated by reference.

### BACKGROUND OF THE INVENTION

The present invention relates to, in optical information processing systems that perform processing, for example, recording, replay, erasure, and the like of optical information recording media, such as an optical disc and the like, an optical pickup having a function of processing a replay signal or a recording signal, which are used in optical head devices as key components of the optical information processing system, and a function of detecting various kinds of servo signals.

For recording highly precise video or information, the recording capacity of a single optical information recording medium must be increased. To do so, it is contemplated to provide a plurality of recording layers in the optical information recording medium. Replay-only media include dedicated optical information recording media, such as a DVD (Digital Versatile Disc)-ROM, DVD-Video, and the like while recording-only media include optical information recording media, such as DVD-R DL (Dual Layer), DVD+R DL (Double layer), and the like, each of which has two recording layers on each single side.

Referring to next-generation optical information recording media, optical information recording media for replay or recording, such as Blu-Ray Disc, HD (High Definition)-DVD, and the like have been developed each of which includes two layers on each single side. Further, optical information recording media for replay or recording are under examination which include four or eight layers on each single side. For replay or recording of an optical information recording medium including a plurality of recording layers on each single side, an optical pickup has been proposed, for example, in Japanese Patent Application Laid Open Publication No. 2001-229573.

FIG. 8 shows a conventional optical pickup having an optically fundamental and general construction using an optical grating (hologram element). As shown in FIG. 8, the conventional optical pickup includes: a semiconductor laser diode 1 emitting a laser light for recording or replay; a collimator lens 2 bundling in parallel the laser light from the semiconductor laser diode 1; an optical grating 3 for diffracting the laser light bundled in parallel into one main beam and two sub beams; a polarization beam splitter 4 changing the direction of a reflected light from an optical information recording medium 5 toward a photodetector 9; a raising mirror 6 raising the three beams toward the optical information recording medium 5; a ¼ wavelength plate 7 arranged between the raising mirror 6 and the optical information recording medium 5 for converting linearly polarized lights into circularly polarized lights; an objective lens 8 focusing the three beams, which have been converted into the circularly polarized lights, on the optical information recording medium 5; a condenser lens 10 arranged between the polarization beam splitter 4 and the photodetector 9 for condensing the reflected light to the photodetector 9; and a hologram element 11 diffracting the reflected light toward the photodetector 9.

FIG. 9 schematically shows the hologram element 11. As shown in FIG. 9, the conventional hologram element 11 is in a circular shape and is provided with a single bisecting line 12 at the center thereof to form two kinds of diffraction areas of a first hologram region 11A and a second hologram region 11B on the respective sides of the bisecting line 12. The direction that the bisecting line 12 extends is so set to be substantially parallel with the tracking direction of the optical information recording medium 5 (in the Y axis direction in FIG. 9) in a light flux pattern of a reflected beam reflected from the optical information recording medium 5. Wherein, the gratings of each hologram region 11A, 11B are in arc shapes.

Accordingly, the three reflected beams (one main beam and two sub beams) are made incident in each hologram region 11A, 11B astride the bisecting line 12 of the hologram element 11, so that at least 12±first order diffracted lights are formed. The photodetector 9 receiving the ±first order diffracted lights has a light receiving face as shown in FIG. 10. This example shows the case employing SSD (Spot Size Detection) method for focus signal detection and DPD (Differential Phase Detection) method and DPP (Differential Push Pull) method for tracking signal detection. Namely, the light receiving face is composed of 12 photo-detecting segments 14 to 25 arranged in three stages with a center line 13 dividing them right and left two by two as a symmetry axis and are arranged so as to correspond to points where the 12±first order diffracted lights reach.

Four the photo-detecting segments 18 to 21 arranged at the second stages in the Y axis direction of the photodetector 9 correspond to light beam spots of the main beam SP1 for performing focus detection and DPD detection. The photo-detecting segments 14 to 17 and 22 to 25 arranged at the first stages and the third stages, respectively, in the Y axis direction correspond to light beam spots of the respective two sub beams SP2, SP3 for performing PDD detection.

Each photo-detecting segment 18 to 21 at the second stages are divided into four in the X axis direction to form four cells. Accordingly, 24 divided regions in total are formed in the light receiving face. Further, the pitch and the pattern of each of the hologram regions 11A, 11B are so formed that lights passing through one 11A of the hologram regions are made incident to the segments 14, 18, 22, and 17, 21, 25 arranged in the outer two rows of the photo-detecting segments in four rows while lights passing through the other hologram region 11B are made incident to the other segments 15, 19, 23 and 16, 20, 24 in the inner two rows thereof.

In this example, a focus error (FE) signal as a servo error signal is detected by SSD method {FE(SSD)} while a tracking error (TE) signal as a servo error signal is detected by DPD method {TE(DPD)} and DPP method {TE(DPP)} (=computation of main push pull {TE(MPP)} and sub push pull {TE(SPP)}). Specifically, the signals are generated from the following computation.

FE(SSD)=(B+C+F+G)−(A+D+E+H)

TE(DPD)=phase(A+B, E+F) +phase(C+D, G+H)

TE(MPP)=(A+B+C+D)−(E+F+G+H)

TE(SPP)=I−J

TE(DPP)=TE(MPP)−Gain(TE(SPP))

Wherein, phase( ) represents phase comparison, Gain( ) represents a predetermined coefficient, and A, B, C, D, E, F, G, H, I, and J are expressed as follows when reference numerals A1, B1, and the like assigned to the light beam spots incident in the respective photo-detecting segments shown in FIG. 10 are used:

A=A1+A2, B=B1+B2, C=C1+C2, D=D1+D2, E=E1+E2, F=F1+F2, G=G1+G2, H=H1+H2, I=I1+I2+I3+I4, and J=J1+J2+J3+J4.

In the case using an optical information recording medium including two recording layers, however, the conventional optical pickup involves a problem of an unnecessary reflected light (generally called a stray light at a boundary with another recording layer) from a recording boundary of a recording layer other than a target recording layer for information recording or replay. Specifically, when a light is detected in a state where a light reflected by a target recording layer for information recording or replay overlaps with a light reflected by a boundary part between a recording region and a non-recorded region of a non-target recording layer, an accurate light amount cannot be obtained. In general, the tracking error signal is detected by differential push pull (DPP). As a result, the stray light at the boundary with another recording layer is caused in recording or replaying of a two-layer optical information recording medium by an optical pickup using a general optical grating (hologram element).

### SUMMARY OF THE INVENTION

The problem of this stray light at the boundary with another recording layer will be described below in detail.

A two-layer optical information recording medium includes two layers of first and second recording layers in the thickness direction of the medium, wherein the first recording layer near to an optical pickup is semitransparent. Change in focus position between the first recording layer and the second recording layer by the optical pickup enable recording or replay with respect to the corresponding recording layer. In detecting a tracking signal of such the two-layer optical information recording medium, a sub push pull signal for tracking the two-layer optical information recording medium becomes disordered. One of factors of disorder of the tracking sub push pull signal is that: a reflected light from a recording region and a non-recording region of the other non-focused recording layer serves as a defocus light to be made incident in the light receiving region of the photodetector 9.

FIG. 11 shows a state where the defocus light is generated. FIG. 11 shows the case where a light is focused on a first recording layer 26 near to the optical pickup out of the first recording layer 26 and the second recording layer 27 included in a two-layer optical information recording medium. In addition to a condensed beam from the focused first recording layer 26, a defocus light from an off-focus (non-focused) layer (the second recording layer 27) is made incident to the light receiving regions of the photodetector 9. The influence of the defocus light becomes the severest when it passes a part ranging over a recording region 28 and a non-recording region 29 of the second recording layer 27. The beam that involves the influence the most is the defocus light of the main beam SP1 out of the three beams. The reason thereof will be described with reference to FIG. 12.

FIG. 12 shows a state where a defocus light 30 of the main beam is made incident so as to cover the photo-detecting segments 14, 15, and the like. A significant amount of the defocus light 30 is made incident in the segments 14, 15, 16, 17, 22, 23, 24, and 25 which generate a TE(SPP) signal. FIG. 13 shows the TE(SPP) signal when the defocus light 30 passes the part ranging over the recording region 28 and the non-recording region 29 of the second recording layer 27. Wherein, no AC signal is included herein. As can be understood from FIG. 13, the TE(SPP) (=I−J) signal wobbles when passing the part ranging over the recording region 28 and the non-recording region 29 of the second recording layer 27 to generate an unstable tracking error (TE) signal. This means that the amplitude difference of the generated TE signal does not becomes zero when both the light beam spot I1 incident in the photo-detecting segment 14 and the light beam spot J1 is incident in the photo-detecting segment 15, for example, move from the recording region 28 to the non-recording region 29 of the second recording layer 27 in the X axis direction. The same problem as that caused when the first recording layer 26 is focused is caused when the second recording layer is focused. The same problem occurs in not only two-layer but three- or more-layer optical information recoding media.

The present invention has its object of enabling addressing to at least a two-layer optical information recording medium and enabling detection of a tracking error that allows more accurate and stable recording and replay operations by solving the above conventional problem.

To attain the above object, the present invention provides a hologram element in an optical pickup which is divided into four regions in directions parallel with and perpendicular to a tracking direction of a recording medium so that two pairs of diffracted lights from two paired regions adjacent in parallel with the tracking direction are made incident so as to align in the direction perpendicular to the tracking direction in respective light receiving elements.

Specifically, an optical pickup in accordance with the present invention includes: a semiconductor laser diode emitting a light beam; an optical grating diffracting the light beam into a plurality of diffracted lights having different orders; a condensing optical system condensing the plurality of diffracted lights diffracted by the optical grating onto a recording face of an optical information recoding medium; a hologram element diffracting a return light reflected by the optical information recording medium; and a plurality of light receiving elements receiving diffracted lights diffracted by the hologram element, wherein the hologram element is divided into a first region, a second region, a third region, and a fourth region by a first bisecting line parallel with a tracking direction of the optical information recording medium and a second bisecting line perpendicular to the tracking direction thereof, the first region and the second region are adjacent to each other in a direction parallel with the tracking direction while the third region and the fourth region are adjacent to each other in the direction parallel with the tracking direction, and the first region and the fourth region are adjacent to each in a direction perpendicular to the tracking direction while the second region and the third region are adjacent to each other in the direction perpendicular to the tracking direction, and diffracted lights diffracted in the first region and the second region of the hologram element are made incident into the plurality of light receiving elements so as to align in the direction perpendicular to the tracking direction while the diffracted lights diffracted in the third region and the fourth region of the hologram element are made incident to the plurality of light receiving element so as to align in the direction perpendicular to the tracking direction.

According to the optical pickup in accordance with the present invention, in detecting the tracking error (TE) signal by, for example, the difference push pull (DPP) method and the sub push pull (SPP) method, a defocus light ranges over the first and second regions or the third and fourth regions, so that the detection signal (amplitude difference signal) thereof becomes zero substantially. This enables generation of a stable tracking error (TE) signal even when a defocus light passes a part ranging over a recording region and a non-recording region of a non-target recording layer.

In the optical pickup of the present invention, it is preferable to arrange the plurality of light receiving elements so as to be divided in the direction parallel with the tracking direction of the optical information recording medium.

In the optical pickup of the present invention, the optical grating preferably diffracts the light beam into a 0-th order diffracted light and ±first order diffracted lights.

In the optical pickup of the present invention, it is preferable that in each of the first region, the second region, the third region, and the fourth region of the hologram element, regions in a form of a strip in plan for imaging at points of the plurality of light receiving elements which are near to the optical information recording medium and regions in a form of a strip in plan for imaging at points of the plurality of light receiving elements which are far from the optical information recording medium are arranged alternately.

In the optical pickup of the present invention, the plurality of light receiving elements are preferably arranged on respective sides of the semiconductor laser diode emitting the light beam.

In the optical pickup of the present invention, the plurality of light receiving elements are preferably formed on a semiconductor substrate, on which the semiconductor laser diode is placed.

In this case, preferably, the semiconductor substrate including the plurality of light receiving element and the semiconductor laser diode is built in a single package together with the optical grating and the hologram element.

In the optical pickup of the present invention, it is preferable that a light receiving element arranged on one of the respective sides of the semiconductor laser diode outputs a signal for focus error signal generation while a light receiving element arranged on the other side of the semiconductor laser diode outputs a signal for tracking error signal generation.

In the optical pickup of the present invention, the optical grating and the hologram element are preferably formed in a single optical member.

In the optical pickup of the present invention, it is preferable that the laser beam that the semiconductor laser diode emits has a wavelength in a 650 nm band.

Alternatively, in the optical pickup of the present invention, it is preferable that the laser beam that the semiconductor laser diode emits has a wavelength in a 405 nm band.

As described above, the optical pickup in accordance with the present invention can address at least a two-layer optical information recording medium and can detect a tracking error signal that allows further accurate and stable recording and replay operations.

### BRIEF DESCRIPTION OF THE DRAWINGS

FIG. 1 is a schematic sectional view showing a main part of an optical system of an optical pickup in accordance with one embodiment of the present invention.

FIG. 2 is a schematic plan view showing a hologram element of the optical pikcup in accordance with one embodiment of the present invention.

FIG. 3 is a schematic plan view showing a layout of light receiving groups in the optical pickup in accordance with one embodiment of the present invention.

FIG. 4 is a schematic sectional view for explaining a defocus light from a two-layer optical information recording medium in the optical pickup in accordance with one embodiment of the present invention.

FIG. 5 is a schematic plan view showing a state where a defocused main beam is made incident in light receiving groups in the optical pickup in accordance with one embodiment of the present invention.

FIG. 6 is a graph showing a tracking error signal TE(SPP) around the boundary between a recording region and a non-recording region in the optical pickup in accordance with one embodiment of the present invention.

FIG. 7 is a schematic plan view showing light beam spots in the case where another diffraction pattern is employed for the hologram element in the optical pickup in accordance with one embodiment of the present invention.

FIG. 8 is an optically fundamental constitutional view showing a conventional optical pickup.

FIG. 9 is a schematic plan view showing a hologram element used in the conventional optical pickup.

FIG. 10 is a schematic plan view showing a layout in a photodetector of the conventional optical pickup.

FIG. 11 is a schematic sectional view for explaining a defocus light from a two-layer optical information recording medium in the conventional optical pickup.

FIG. 12 is a schematic plan view showing a state where a defocused main beam is made incident in the photodetector of the conventional optical pickup.

FIG. 13 is a graph showing a tracking error signal TE(SPP) around the boundary between a recording region and a non-recording region in the conventional optical pickup.

### DESCRIPTION OF THE PREFERRED EMBODIMENTS

### Embodiment

One embodiment of the present invention will be described below with reference to the accompanying drawings.

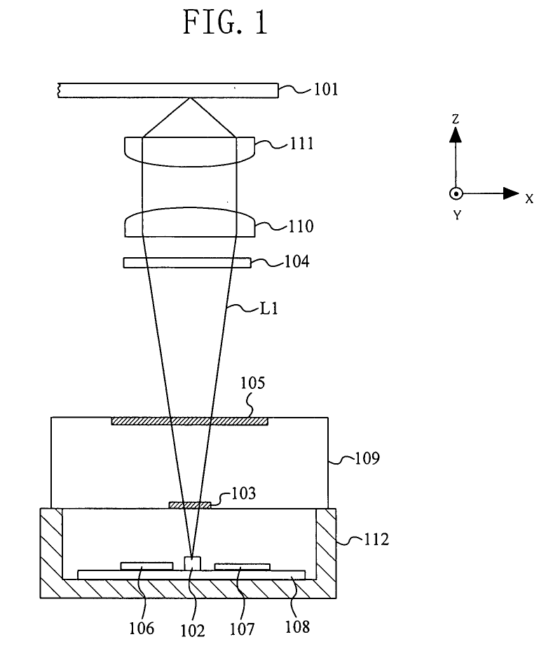

FIG. 1 schematically shows a construction of an optical pickup in accordance with one embodiment of the present invention. As shown in FIG. 1, the optical pickup in accordance with the present embodiment includes a semiconductor laser diode 102, an optical grating 103, a ¼ wavelength plate 104, a hologram 105, a first light receiving group 106, and a second light receiving group 107. The semiconductor laser diode 102 emits a light beam L1 having a wavelength used for recording and relay of an optical information recording medium 101. The optical grating 103 diffracts the light beam L1 into a main beam as a 0-th order diffracted light and sub beams as ±first order diffracted lights (not shown). The ¼ wavelength plate 104 polarizes the linearly polarized (p-polarized) light beam L1 into a circularly polarized light. The hologram element 105 diffracts the laser beam L1 reflected by the optical information recording medium 101. The first and second light receiving groups 105, 107 receive the diffracted lights from the hologram element 105.

Herein, the first light receiving group 106 as a light receiving group for tracking error signal generation and the second light receiving group 107 as a light receiving group for focus error signal generation are formed on the principal face of one integrated circuit board 108 with a space left from each other. The semiconductor laser diode 102 is placed in a region of the principal face of the integrated circuit board 108 between the first light receiving group 106 and the second light receiving group 107.

The optical grating 103 and the hologram element 105 are formed in an optical substrate 109 as an integral optical element.

Between the ¼ wavelength plate 104 and the optical information recording medium 101, there are provided a collimator lens 110 converting the light beam L1 from the semiconductor laser diode 102 into a bundle of parallel beams and an objective lens 111 focusing the light beam L1 bundled in parallel onto one of recording faces of the optical information recording medium 101.

The integrated circuit board 108 is mounted inside a package 112, and the optical substrate 109 is fixed at the upper part of the package 112 in which the integrated circuit board 108 is built. It is noted that the integrated circuit board 108 may be built in the package 112 together with the optical substrate 109 including the hologram element 105 and the optical grating 103.

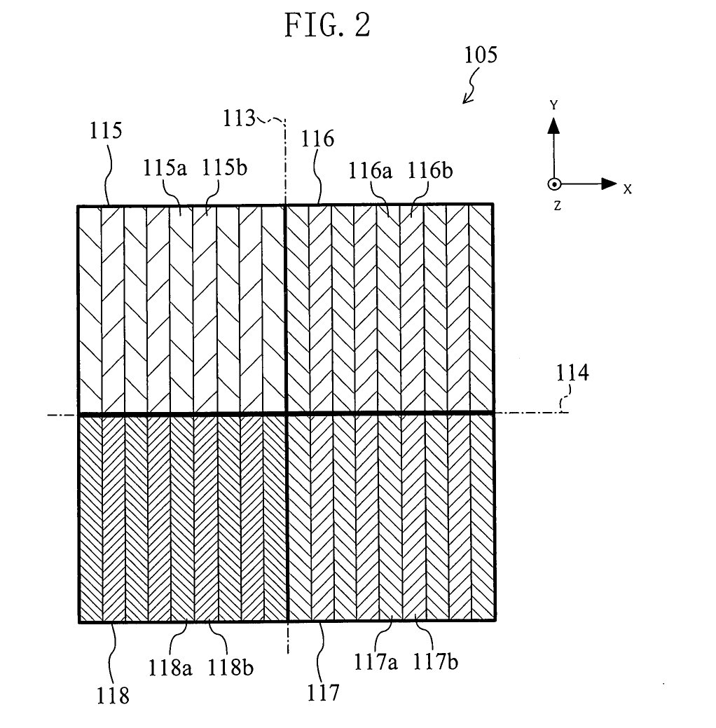

A structure of the hologram element 105 in accordance with the present embodiment will be described below. As shown in FIG. 2, the hologram element 105 in accordance with the present embodiment is divided into four regions 115, 116, 117, and 118 by a first bisecting line 113 extending in a direction (Y axis direction) parallel with a track of the optical information recording medium 101 and a second bisecting line extending in a direction (X axis direction) perpendicular to the track thereof. The four regions 115 to 118 of the hologram element 105 are respectively formed of alternately arranged strips in plan of sub regions 115a, 116a, 117a, 118a and sub regions 115b, 116b, 117b, 118b. The sub regions 115a, 116a, 117a, 118a allow imaging at points of the respective light receiving groups 106, 107 which are near to the optical information recording medium 101 while the sub regions 115b, 116b, 117b, 118b allow imaging at points of the respective light receiving groups 106, 107 which are far from the optical information recording medium 101.

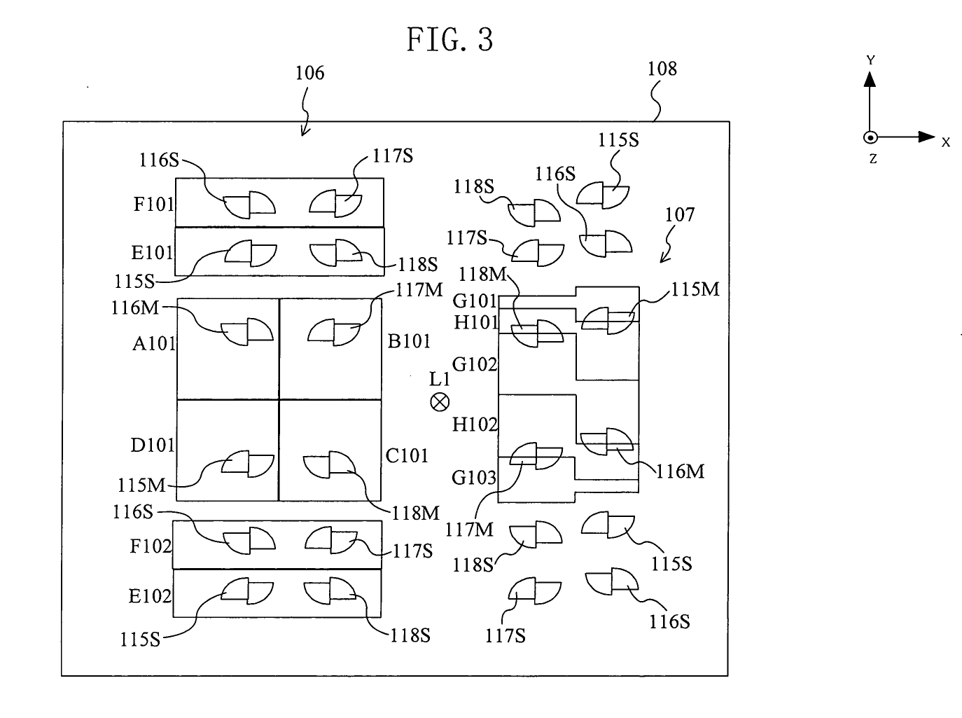

Next, FIG. 3 shows a layout pattern of the first light receiving group 106 and the second light receiving group 107 in accordance with the present embodiment. As shown in FIG. 3, a third stage in the Y axis direction of the first light receiving group 106 is divided into two regions F101, E101 in parallel with the X axis direction, and a first stage in the Y axis direction thereof is divided into two regions F101 and F102 in parallel with the X axis direction. Referring to a second stage in the Y axis direction of the first light receiving group 106, it is divided into two regions in the X axis direction and two regions in the Y axis direction to form regions A101, B101, C101, and D101.

The second light receiving group 107 is divided substantially in the X axis direction into five regions irregular in size.

The main beam incident in the hologram 105 shown in FIG. 2 is diffracted in the region 115 to form a plurality of light beam spots 115M shown in FIG. 3; is diffracted in the region 116 to form a plurality of light beam spots 116M shown in FIG. 3; is diffracted in the region 117 to form a plurality of light beam spots 117M shown in FIG. 3; and is diffracted in the region 118 to form a plurality of light beam spots 118M shown in FIG. 3. The sub beams incident in the hologram element 105 are diffracted in the region 115 to form a plurality of light beam spots 115S shown in FIG. 3; are diffracted in the region 116 to form a plurality of light beam spots 116S shown in FIG. 3; are diffracted in the region 117 to form a plurality of light beam spots 117S shown in FIG. 3; and are diffracted in the region 118 to form a plurality of light beam spots 118S shown in FIG. 3.

Description will be given below to an operation of the thus constructed optical pickup in accordance with the present embodiment.

First, for replaying information of the optical information recording medium 101 shown in FIG. 1 or recoding different information, the semiconductor laser diode 102 is driven, the light beam L1 emitted from the semiconductor laser diode 102 is diffracted by the optical grating 103 into the main beam as a 0-th order diffracted light and the sub beams (not shown) of+first order diffracted lights. Then, the light beam L1, which has been diffracted into p-polarized lights, is polarized into circularly polarized lights by the ¼ wavelength plate 104, passes through the collimator lens 110 and the objective lens 111, and is condensed on and reflected by the optical information recording medium 101. The reflected light passes through the objective lens 111 and the collimator lens 110 again, is made incident to the ¼ wavelength plate 104 to be a s-polarized light, and is then made incident to the hologram element 105 as light beam branching means.

Next, a focus error (FE) signal and a tracking error (TE) signal as servo error signals are detected. The focus error (FE) signal is detected by spot size detection (SSD) method {FE(SSD)} while the tracking error (TE) signal is detected by differential phase detection (DPD) method {TE(DPD)} and differential push pull (DPP) method {TE(DPP)} (=computation of main push pull {TE(MPP)} and sub push pull {TE(SPP)}). Specifically, the signals are generated from the following computation.

FE(SSD)=G−H

TE(DPD)=phase(A, D)−phase(B, C)

TE(MPP)=(C+D)−(A+B)

TE(SPP)=E−F

TE(DPP)=TE(MPP)−Gain(TE(SPP))

Wherein, phase( ) represents phase comparison, Gain( ) represents a predetermined coefficient, and A, B, C, D, E, F, G, and H are expressed as follows when reference numerals A101, B101, and the like assigned to the photo-detecting segments shown in FIG. 3 are used:

A=A101, B=B101, C=C101, D=D101, E=E101+E102, F=F101+F102, G=G101+G102+G103, and H=H101+H101.

Description will be given next to a method for processing a defocus light from a non-target recording layer in the case using a two-layer optical information recording medium.

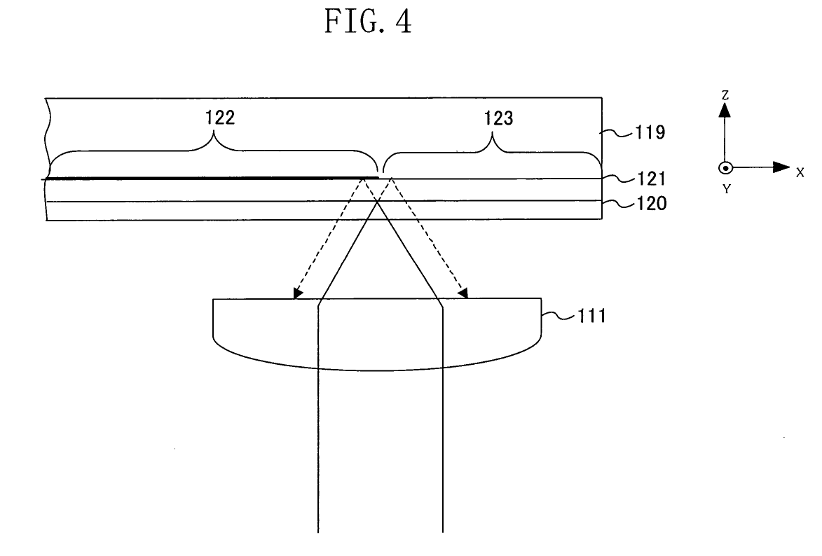

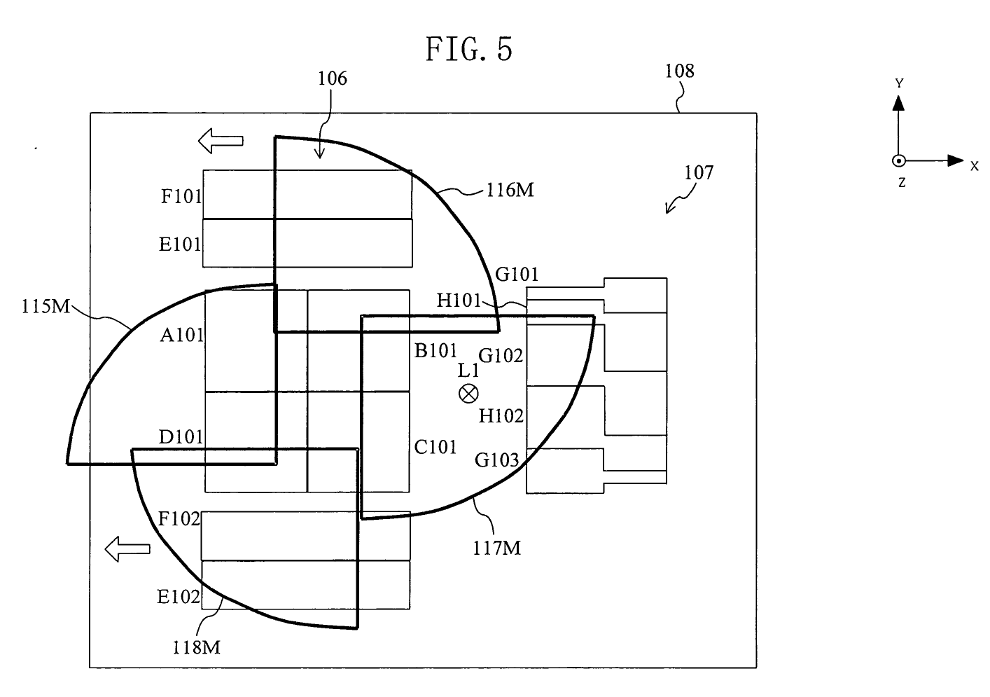

FIG. 4 shows a state where of a first recoding layer 120 and a second recording layer 121 included in a two-layer optical information recording medium 119, the first recording layer 120 near to the optical pickup is focused. In addition to a condensed beam from the focused first recording layer 120, defocus lights from another non-focused off-focus layer (the second recording layer 121) are incident to the first and second light receiving groups 106, 107. The influence of the defocus lights becomes the severest when they pass a part ranging over a recording region 122 and a non-recording region 123 of the second recording layer 121. Defocus lights from the main beam out of the three beams have the most significant influence. FIG. 5 shows a state where defocus lights 115M, 116M, 117M, and 118M of the main beam are made incident so as to cover the photo-detecting segments F101, E101, and the like. Herein, only the defocus lights incident to the first light receiving group 106 for tracking error (TE) signal generation are shown. It is understood that a large amount of defocus lights 116M, 118M are made incident to the photo-detecting segments E101, F101, E102, and F102 that generate a TE (SPP) signal.

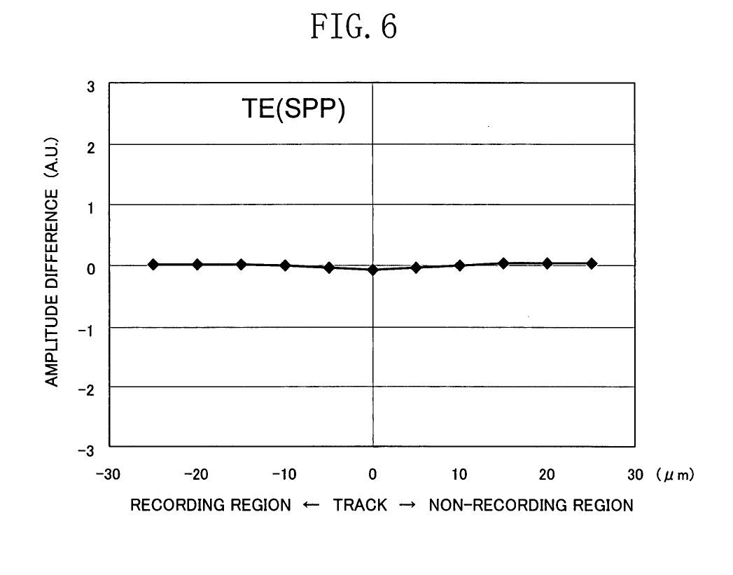

FIG. 6 indicates the TE (SPP) signal when a defocus light passes the part ranging over the recoding region 122 and the non-recording region 123 of the second recording layer 121, as shown in FIG. 4. Herein, no AC signal is included. As shown in FIG. 6, the TE (SPP) (=E−F) signal generates a tracking error signal which is almost flat and stable even when the defocus light from the non-target second recording layer 121 passes the part ranging over the recording region 122 and the non-recording region 123 of the non-focused second recording layer 121. This is because the defocus light in the recording region 122 and the non-recording region 123 of the recording layer 121 moving in the X axis direction is made incident substantially uniformly to, for example, the photo-detecting segments E101 and F101 so that the detection signal (amplitude differential signal) thereof becomes zero substantially. This enables generation of a stable tracking error signal.

In the present invention, a stable tracking error signal can be generated as well when the second recording layer 121 is focused.

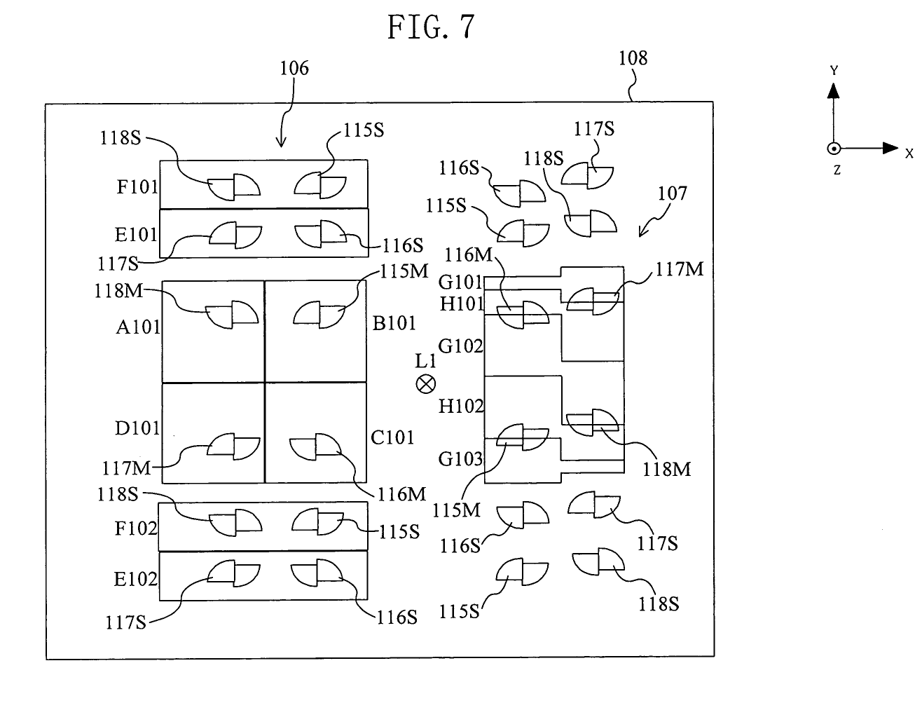

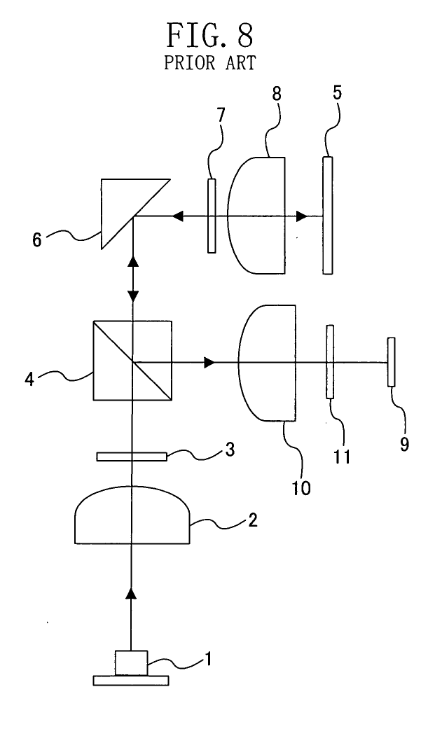

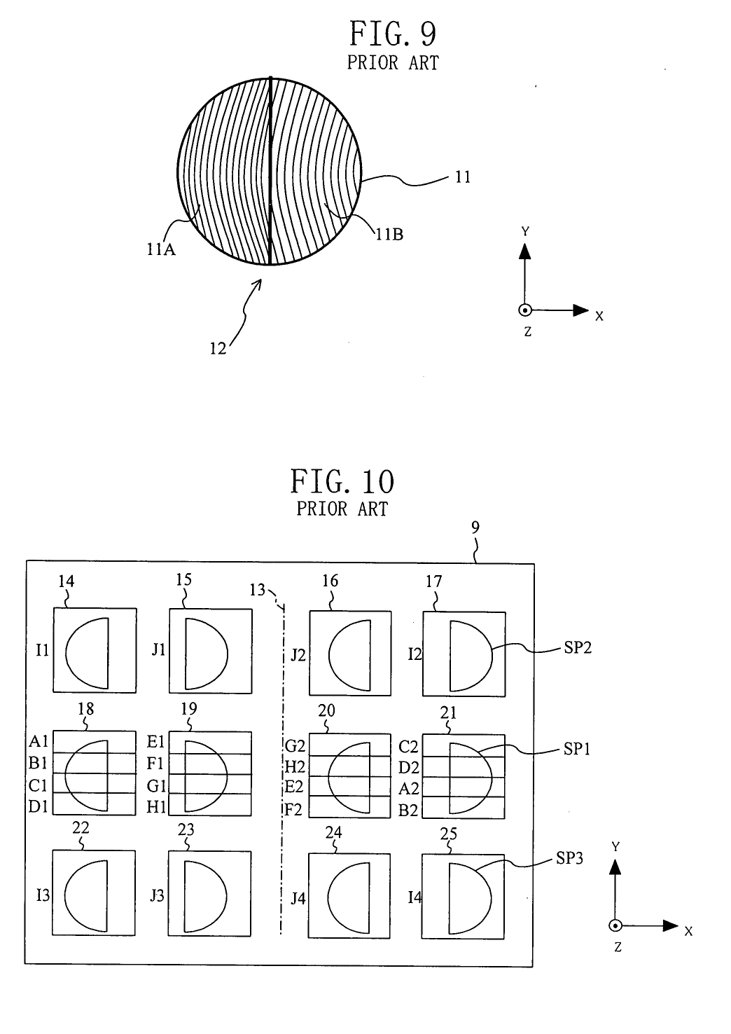

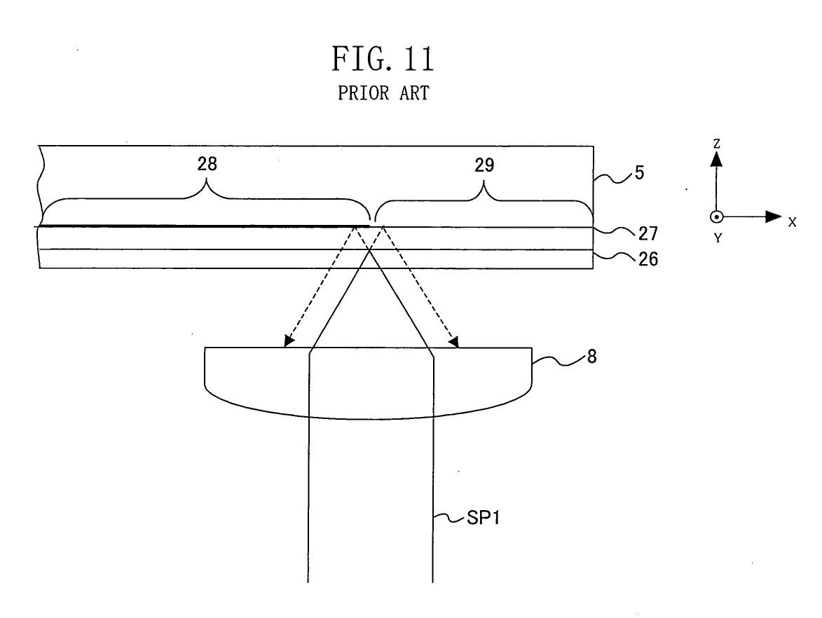

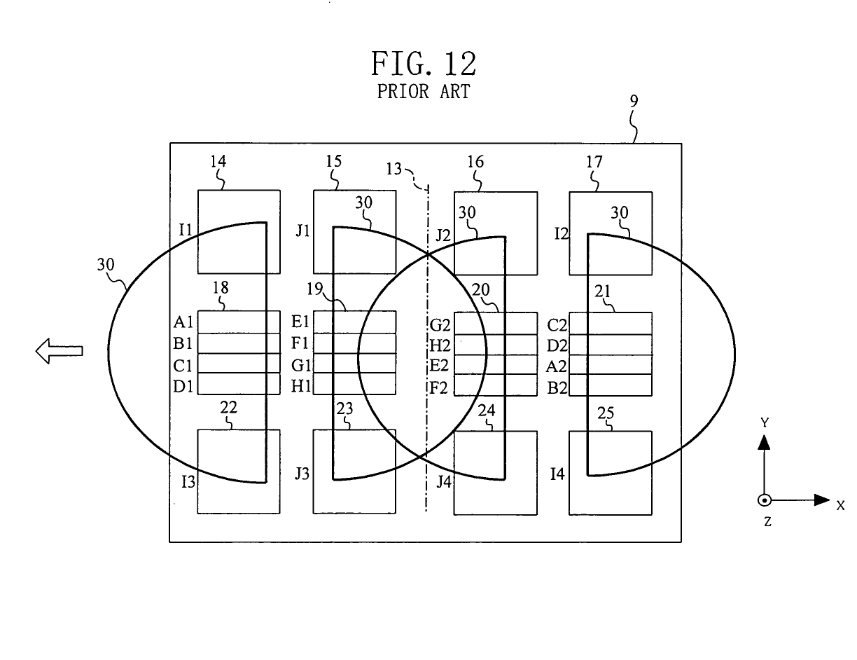

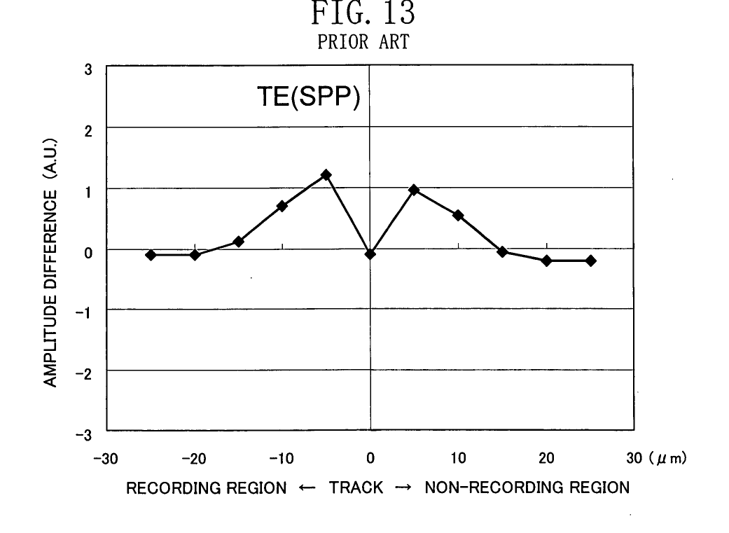

The arrangement of the light beam spots shown in FIG. 3 has been referred to as one example of the diffraction pattern of the hologram element 105 in accordance with the present embodiment, but the present invention is not limited thereto. For example, the light beam spots may be arranged as shown in FIG. 7 as one modified example. Specifically, the light beam spots 115S of the sub beams from the region 115 of the hologram element 105 are incident to the photo-detecting segments F101, F102 of the first light receiving element group 106, rather than the photo-detecting segments E101 and E102 of the first light receiving group 106.

As well, the optical information recording medium has two recording faces in the above embodiment as one example of the optical information recording media having a plurality of layers of recording faces, but the present invention is not limited thereto and the optical information recording medium may include three or more layers of recording faces. Even with three or more recording faces, the same effects as the case with the two layers are exhibited.

The optical pickup in accordance with the present embodiment has a construction addressing an optical information recording medium for recording and replay, but the optical pickup in the present invention is not limited thereto and may for recoding only or replay only.

Further, the present embodiment refers to the construction in which the ¼ wavelength plate 104 is arranged between the hologram element 105 and the collimator lens 110, as shown in FIG. 1, but the ¼ wavelength plate 104 may be integral with the hologram element 105. Alternatively, the ¼ wavelength platen 104 may be arranged between the objective lens 111 and the collimator lens 110.

In the present embodiment, the light beam L1 emitted from the semiconductor laser diode 102 may have a wavelength in a 650 nm band addressable to an optical information recording medium 101 belonging to a DVD system or in a 405 nm band addressable to an optical information recoding medium 101 belonging to a HD-DVD system or a Blu-Ray Disc system.

As described above, the optical pickup in accordance with the present invention can address at least two-layer optical information recording medium and can detect a tracking error signal that enables further accurate and stable recording and replay, and therefore, the present invention is useful for optical pickups having a function of processing a replay signal or a recording signal used for an optical head system and a function of detecting various kinds of servo signals.

What is claimed is:

1. An optical pickup, comprising:
a semiconductor laser diode emitting a light beam;
an optical grating diffracting the light beam into a plurality of diffracted lights having different orders;
a condensing optical system condensing the plurality of diffracted lights diffracted by the optical grating onto a recording face of an optical information recoding medium;
a hologram element diffracting a return light reflected by the optical information recording medium; and
a plurality of light receiving elements receiving diffracted lights diffracted by the hologram element,
wherein the hologram element is divided into a first region, a second region, a third region, and a fourth region by a first bisecting line parallel with a tracking direction of the optical information recording medium and a second bisecting line perpendicular to the tracking direction thereof,
the first region and the second region are adjacent to each other in a direction parallel with the tracking direction while the third region and the fourth region are adjacent to each other in the direction parallel with the tracking direction, and the first region and the fourth region are adjacent to each in a direction perpendicular to the tracking direction while the second region and the third region are adjacent to each other in the direction perpendicular to the tracking direction, and
diffracted lights diffracted in the first region and the second region of the hologram element are made incident into the plurality of light receiving elements so as to align in the direction perpendicular to the tracking direction while the diffracted lights diffracted in the third region and the fourth region of the hologram element are made incident to the plurality of light receiving element so as to align in the direction perpendicular to the tracking direction.

2. The optical pickup of claim 1,
wherein the plurality of light receiving elements are arranged so as to be divided in the direction parallel with the tracking direction of the optical information recording medium.

3. The optical pickup of claim 1,
wherein the optical grating diffracts the light beam into a 0-th order diffracted light and ±first order diffracted lights.

4. The optical pickup of claim 1,
wherein in each of the first region, the second region, the third region, and the fourth region of the hologram element, regions in a form of a strip in plan for imaging at points of the plurality of light receiving elements which are near to the optical information recording medium and regions in a form of a strip in plan for imaging at points of the plurality of light receiving elements which are far from the optical information recording medium are arranged alternately.

5. The optical pickup of claim 1,
wherein the plurality of light receiving elements are arranged on respective sides of the semiconductor laser diode emitting the light beam.

6. The optical pickup of claim 1,
wherein the plurality of light receiving elements are formed on a semiconductor substrate, on which the semiconductor laser diode is placed.

7. The optical pickup of claim 6,
wherein the semiconductor substrate including the plurality of light receiving element and the semiconductor laser diode is built in a single package together with the optical grating and the hologram element.

8. The optical pickup of claim 5,
wherein a light receiving element arranged on one of the respective sides of the semiconductor laser diode outputs a signal for focus error signal generation while a light receiving element arranged on the other side of the semiconductor laser diode outputs a signal for tracking error signal generation.

9. The optical pickup of claim 1,
wherein the optical grating and the hologram element are formed in a single optical member.

10. The optical pickup of claim 1,
wherein the laser beam that the semiconductor laser diode emits has a wavelength in a 650 nm band.

11. The optical pickup of claim 1,
wherein the laser beam that the semiconductor laser diode emits has a wavelength in a 405 nm band.
